(19) United States
(12) Patent Application Publication
(10) Pub. No.: US 2014/0111510 A1
(43) Pub. Date: Apr. 24, 2014

(54) METHOD FOR OPTIMIZED POLYGON REDUCTION OF COMPUTER GRAPHICS

(71) Applicant: DONYA LABS AB, Linkoping (SE)

(72) Inventors: Ulrik Lindahl, LJUNGSBRO (SE); Gustaf Johansson, STOCKHOLM (SE)

(73) Assignee: DONYA LABS AB, Linkoping (SE)

(21) Appl. No.: 13/656,006

(22) Filed: Oct. 19, 2012

(51) Int. Cl. G06T 17/10

(52) U.S. Cl. CPC G06T 17/10
USPC 345/420

(57) ABSTRACT

The present invention relates to a computer implemented method for optimizing polygon reductions of a three-dimensional graphics object. The present invention also relates to a corresponding image processing apparatus and a computer program product.

### TECHNICAL FIELD

The present invention generally relates to computer graphics and more specifically to a computer implemented method for optimizing polygon reductions of a three-dimensional graphics image. The present invention also relates to a corresponding image processing apparatus and a computer program product.

### BACKGROUND OF THE INVENTION

The creation and interactive visualization of artificial computer graphics (CG) environments is an important application in the field of computer graphics. Many applications, such as CAD, architectural walkthroughs, simulations, medical visualization and computer games include interactive navigation, i.e., being able to move around a computer model/scene at greater than 10 frames per second.

A common trend within the field of interactive computer graphics is the increasing amount of CG datasets. Large CG datasets require specialized graphics systems used to accelerate the process. However, models exist that cannot be rendered at interactive speeds even with current high-end computer hardware. The development of computer hardware is not likely to solve the described problems since the size of the CG data and the size of the secondary computer memory is increasing at faster rates than the development of thereto related hardware.

CG data is often represented using triangle meshes, or even more generally using a plurality of polygons. These meshes are typically not optimized for display or simulation performance. In most applications, the initial meshes can usually be replaced by optimized versions that could be approximations with far fewer faces, or containing other properties that make them more suited for particular applications such as mentioned above.

To prevent a decrease in calculation speed, an automatic technique of creating three-dimensional GC data with a small number of triangles/polygons in advance is often employed. However, in employing an automated process for polygon reduction, sometimes an undesirable visual error occurs. Generally, the graphical designer responsible for the specific GC dataset must then manually make suitable adjustments for achieving a visually appealing, but still polygon reduced, GC dataset. Accordingly, it would be desirable to allow for further automation of the polygon reduction process, reducing cost and possibly achieving a more optimized polygon reduced GC dataset.

### SUMMARY OF THE INVENTION

According to a first aspect of the invention, the above is at least partly alleviated by a computer implemented method for optimizing polygon reduction of an initial three-dimensional graphics image, the method comprising performing a first polygon reduction process, resulting in a first three-dimensional graphics image being a polygon reduced representation of the initial three-dimensional graphics image, comparing the first three-dimensional graphics image with the initial three-dimensional graphics image, determining a visual error metric based on the result of the comparison between the first three-dimensional graphics image and the initial three-dimensional graphics image, and performing a second polygon reduction process, resulting in a second three-dimensional graphics image being a polygon reduced representation of the initial three-dimensional graphics object, if the visual error metric is outside of a predetermined error range.

By means of the invention, it is possible to automate the identification of visual error appearing when executing a polygon reduction process, thus resulting in the advantage of reducing cost by minimizing the amount of manual labor needed for achieving e.g. a visually appealing resulting polygon reduced image. This is according to the present invention achieved by determining a difference between an “original” image and an image resulting from an initial polygon reduction process. In case a visual error metric being a result of the comparison/determination, exceeds (or being less than) a predetermined error range, an adaptation is made to the polygon reduction process (i.e. the second polygon reduction process) for the purpose of re-iterating the polygon reduction such that a resulting image (e.g. to be displayed on a computer screen) better matches a desired “quality level”.

It should within the context of the present invention be understood that the visual error metric could be based on a single as well as plurality of different “views” of the three-dimensional image. In the case with a plurality of views of the three-dimensional image, this plurality of views may e.g. be merged or accumulated into one single view-independent visual error metric or represented with a separate view-dependent visual error metric for each (or at least some) of the plurality of views of the three-dimensional image.

The error range may for example be based on a desired visual appearance of the resulting image, and/or in combination with a predetermined polygon reduction ratio (i.e. when comparing the initial with the resulting image in relation to number of polygons) or “polygon budget” for the resulting image.

Generally, the initial, the first and the second three-dimensional graphics image is a polygonal image comprising a plurality of polygons forming a 3-D computer graphics image. As discussed above, three-dimensional computer graphics may for example be used in relation to real-time visualization, computer games, CAD related software, etc.

Furthermore, an exemplary advantage with the invention relates to the possibility of pin-pointing “problem areas” within the original and/or the polygon reduced image(s). Such an advantage provides for the possibility of introducing a less exact and faster visual error metric, thereby giving a faster iterative initial result that is then further refined by multiple passes of the full version of the selected (i.e. second) polygon reduction process.

In a preferred embodiment, the second polygon reduction process introduces a lower level of polygon reduction as compared to the first polygon reduction process. Accordingly, in case the visual error metric exceeds the predetermined error range, the second polygon reduction process is selected to not reduce the number of polygons as “hard” as was initially achieved using the first polygon reduction process.

However, alternatively the second polygon reduction process may instead introduce a higher level of polygon reduction as compared to the first polygon reduction process. Thus, conversely, in case the determined visual error metric is identified to be less than what was desired (or expected), it may be possible to select a second polygon reduction process configured to achieve a higher level of polygon reduction (i.e. resulting in fewer polygons in regards to the second image as compared to the first image).

Based on the above, it should be understood (but not a necessity) that the method according to the invention may be performed only once, or iterated for a plurality of times. For example, in case a comparison between the second image and initial image results in a visual error metric being outside of the error range, a further adjustment may be made in relation to the selection/configuration of the polygon reduction process for providing the resulting image.

Preferably, the second polygon reduction process is selected from one of a plurality of predetermined polygon reduction processes. In any case, the expression “polygon reduction process” should be interpreted broadly, e.g. completely different types of polygon reduction processes may be applied, as well as allowing a specific (for example proprietary) polygon reduction process to be configurable in regards to the level of polygon reduction.

In a preferred embodiment, the method further comprises segmenting the three-dimensional graphics image into a plurality of portions, wherein the determination of the visual error metric is performed for each of the plurality of portions of the three-dimensional graphics image (and possibly for a plurality of different views of the image). In such an embodiment, the three-dimensional graphics image, e.g. being one of the initial, the first and the second three-dimensional graphics image is subdivided in to a plurality of sub-sections, where the visual error metric is determined for each of the sub-sections. Thereby, the selection of polygon reduction processes may then in a suitable manner be made based on the “severity” of error for that specific portion, e.g. different “types” (or configured) polygon reduction processes may be selected for two adjacently arranged portions of the image. Any number of portions may be selected from the graphics image. According to the invention, the segments may also (or alternatively) be formed based on a “clustering technique where “error areas” are formed based on adjacent errors.

In a possible embodiment of the present invention, it may additionally be possible to provide the visual error metric to a user, and (then) receive a user adjusted visual error metric, wherein providing the visual error metric and receiving the user adjusted visual error metric are performed prior to performing the second polygon reduction process. Accordingly, by such an addition it may for example be possible to, prior to performing the second (adjusted) polygon reduction process, e.g. visualize the visual error metric to a user performing the polygon optimization process. Such a visualization may allow the user to e.g. make manual adjustments to the visual error metric, thus providing for the possibility of using the users prior knowledge of a specific feature of the three-dimensional image (e.g. future placement within a game, or areas where higher error may be allowable), thus further optimizing the polygon reduction process.

According to another aspect of the present invention there is provided an image processing apparatus for optimizing polygon reductions of a three-dimensional graphics object, comprising means for performing a first polygon reduction process, resulting in a first three-dimensional graphics image being a polygon reduced representation of the initial three-dimensional graphics image, means for comparing the first three-dimensional graphics image with the initial three-dimensional graphics image, means for determining a visual error metric based on the result of the comparison between the first three-dimensional graphics image and the initial three-dimensional graphics image, and means for performing a second polygon reduction process, resulting in a second three-dimensional graphics image being a polygon reduced representation of the initial three-dimensional graphics object, if the visual error metric is outside of a predetermined error range. This aspect of the invention provides similar advantages as discussed above.

In an embodiment, the image processing apparatus is further configured to allow for display of at least one of the initial, the first or the second three-dimensional graphics image on a computer screen.

The invention is preferably provided on a computer-readable storage medium storing a program which causes a computer to execute an image processing method as discussed above.

According to further aspect of the invention there is provided a computer program product comprising a computer readable medium having stored thereon computer program means for controlling an image processing apparatus configured for optimizing polygon reductions of a three-dimensional graphics object, wherein the computer program product comprises code for performing a first polygon reduction process, resulting in a first three-dimensional graphics image being a polygon reduced representation of the initial three-dimensional graphics image, code for comparing the first three-dimensional graphics image with the initial three-dimensional graphics image, code for determining a visual error metric based on the result of the comparison between the first three-dimensional graphics image and the initial three-dimensional graphics image, and code for performing a second polygon reduction process, resulting in a second three-dimensional graphics image being a polygon reduced representation of the initial three-dimensional graphics object, if the visual error metric is outside of a predetermined error range. Also this aspect of the invention provides similar advantages as discussed above in relation to the previous aspects of the invention.

The image processing apparatus is preferably a server, a general computer, a micro processor or any other type of computing device. Similarly, the computer readable medium may be any type of memory device, including one of a removable nonvolatile random access memory, a hard disk drive, a floppy disk, a CD-ROM, a DVD-ROM, a USB memory, an SD memory card, or a similar computer readable medium known in the art.

In an embodiment and in a similar manner as discussed above, the computer program product is further configured to allow for display of at least one of the initial, the first or the second three-dimensional graphics image on a computer screen.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIGS. 1a and 1b show an example of an original and a polygon reduced three-dimensional graphics image, respectively;

FIG. 2 illustrates a conceptual image processing system according to a currently preferred embodiment of the invention;

FIG. 3 shows a flow chart of method steps according to an embodiment of the invention, and

FIGS. 4a, 4b, 4c and 4d illustrate three-dimensional graphics images at different processes of the inventive method.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

In a system with a three-dimensional graphics accelerator, an application program generates three-dimensional geometry data including information corresponding to points on the surface of a three-dimensional graphical image. These points are usable as vertices of polygons which, when connected, may be rendered to form a representation of the graphical image. Typically, the application program transfers the three-dimensional geometry data to a graphics accelerator and renders the encoded polygons on e.g. a computer screen.

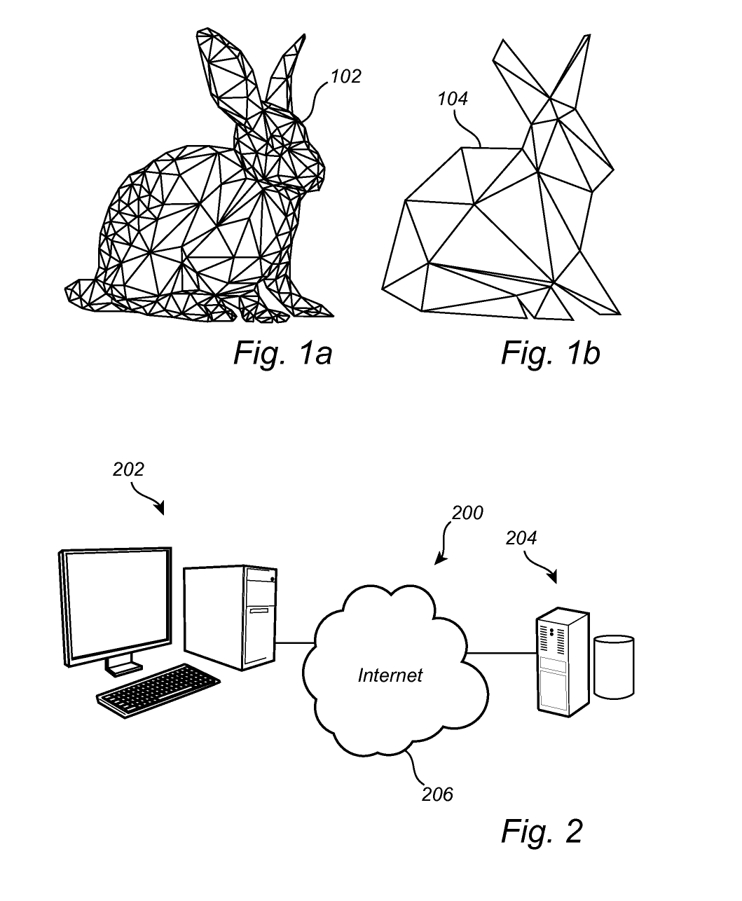

The process of connecting three-dimensional vertices to form a representation of a graphical image may be referred to as creating a polygon mesh. FIGS. 1a and 1b illustrates two different versions of an exemplary three-dimensional graphics image, in the form of a “bunny”, which have been tiled into such a polygon mesh. The first version of the bunny 102 is represented by a large plurality of polygons, whereas the second version of the bunny 104 is represented by a reduced number of polygons as compared to the first version of the bunny 102. The polygon reduction process typically takes place by removing vertices and edges that constitute the mesh model 102, where different levels of polygon reduction may be selected based on a predetermined desired ratio (i.e. original in comparison to the reduced image), pixel based, or based on a polygon budget for the specific image (or object).

As discussed above, the present invention generally relates to a computer implemented method for optimizing polygon reduction of an initial three-dimensional graphics image, specifically taking into account a visual error metric generated based on a difference between an original image and a polygon reduced representation of the original image. Accordingly, the original image could be corresponding to the first version of the bunny 102, whereas the polygon reduced representation could be corresponding to the second version of the bunny 104.

The general concept of the present invention may typically be implemented in an image processing apparatus including a general purpose processor (e.g. a user controlled personal computer), an application specific processor, a circuit containing processing components, a group of distributed processing components, a group of distributed computers configured for processing, etc. The processor may be or include any number of hardware components for conducting data or signal processing or for executing computer code stored in memory. The memory may be one or more devices for storing data and/or computer code for completing or facilitating the various methods described in the present description. The memory may include volatile memory or nonvolatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection) and includes computer code for executing one or more processes described herein.

However, as is shown in the conceptual illustrations provided in FIGS. 1a and 1b, the general functionality of the inventive image processing apparatus may also and/or alternatively be provided in a distributed environment, for example by means of an image processing system 200. In such an implementation, the image processing system 200 may be configured to comprise a user controlled computing device 202 (e.g. the user controlled personal computer) connected to a server/database arrangement 204 over the Internet 206. Accordingly, resources for performing the inventive concept may typically be divided between the computing device 202 and the server/database arrangement 204.

Further to reducing the hardware constrains on the user controlled computing device 202, it would according to the invention be possible to e.g. “on-demand” provide a user/customer with the functionality provided by means of the inventive concept. As an example, a user wanting to generate a polygon reduced image based on an original three-dimensional graphics image may, through a user interface shown on the computing device 202, access a computer implementation of the optimizing polygon reduction running on the server 204. Alternatively, the computing device 202 may be provided with software for producing the original image (such as for example 3D Studio Max, Maya, etc.), where the software running on the computing device 202 is adapted to access/interact with (by means of e.g. an API and “on-demand”, as a subscription, as a fixed service, etc.) a computer implementation of the inventive concept running on the server 204.

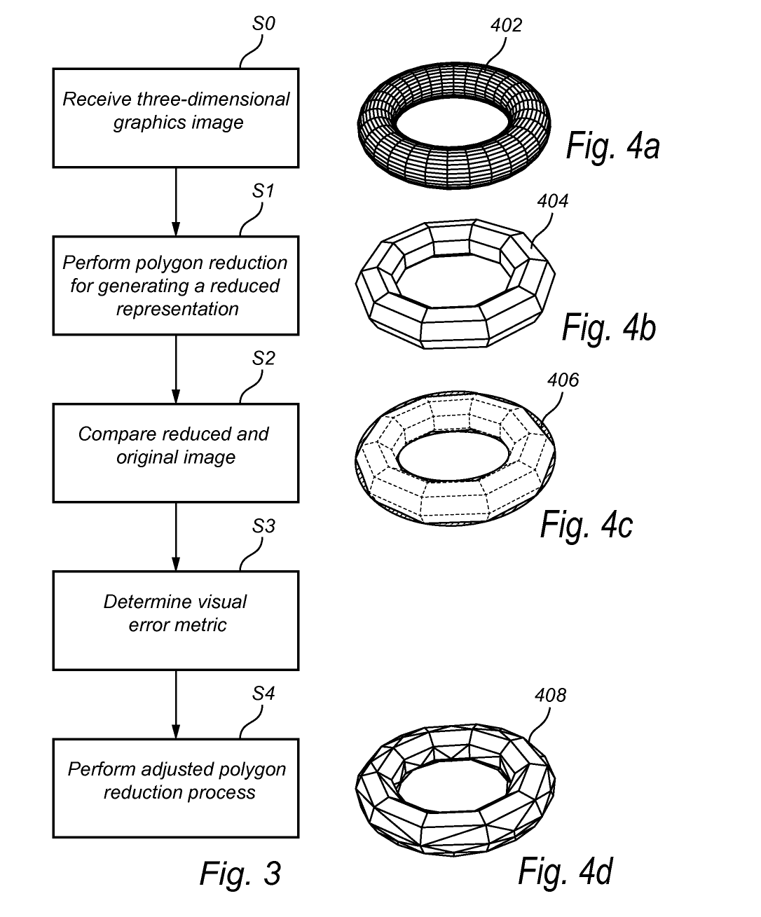

In performing the inventive concept, with further reference to FIGS. 3 and 4a through 4d, the process starts with a image processing apparatus, e.g. in the form of the combined image processing system 200 controlled by the user of the computing device 202, receives, S0, a single (one or a plurality of) three-dimensional graphics image(s) 402, represented as an initial or original three-dimensional graphics image/object. Following the reception of the initial image 402, a first polygon reduction process is performed, S1, resulting in a first three-dimensional graphics image 404 being a polygon reduced representation of the initial three-dimensional graphics image 402. As discussed above, the first polygon reduction process may be a “high-end” process having a targeted polygon budget, or may be more of a “low-end” process for identifying problem areas within the first three-dimensional graphics image 404.

Accordingly, following the step of performing the first polygon reduction process, the first three-dimensional graphics image 404 is compared, S2, with the initial three-dimensional graphics image 402, for example generating a “comparison image” 406 being indicative of the difference between the processed and the original image 404, 402, respectively. The comparison image 406 may be used for determining, S3, a visual error metric. As stated above, the visual error metric may be determined for a single as well as for a plurality of views for the three-dimensional graphics image.

Following the determination of a single or a plurality of visual error metrics, if it is determined that the visual error metric is outside of a predetermined error range, the process is continued by taking into account the (single or plurality of) visual error metrics for performing, S4, a second polygon reduction process, the second polygon reduction process being at least in part different from the first polygon reduction process, where the difference is dependent on the determined visual error metric(s). For example, a completely different polygon reduction process may be selected, or the algorithm for performing the polygon reduction may be adjusted.

Within the context of the inventive concept, the visual error metric(s) may be “area” dependent, e.g. it may be possible to determine “error clusters”. Put differently, it may be possible to determine if some areas (i.e. portions) of the first three-dimensional graphics image 404 in a larger extent than other areas of the first three-dimensional graphics image 404 differs from the initial three-dimensional graphics image 402. Accordingly, these problem areas may be given a higher polygon budget when performing the second polygon reduction process. The visual error metric(s), including information as to specific problem areas and the possible redistribution of a desired polygon budget may be provided to the second polygon reduction process as meta-data.

The process may be iterated for a number of times until a stop condition is reached, including for example the iteration reaching a predetermined maxima and/or the visual error metric(s) falling within a predetermined error range, resulting in a second three-dimensional graphics image 408 being a polygon reduced representation of the initial three-dimensional graphics image 402.

In relation to the predetermined error, in the above description as well as in relation to FIGS. 4a through 4d it is indicated that the process is iterated for the purpose of reducing the difference between the initial three-dimensional graphics image 402 and the polygon reduced representation of the initial three-dimensional graphics image 402 (i.e. the first and/or the second three-dimensional graphics image 404, 408). It should however be understood that the process may be iterated for “increasing the error” between the initial and the resulting three-dimensional graphics image. Accordingly, it may be desirable to increase the difference (i.e. error) between the initial and the resulting image in case the resulting image is “too good”, thereby allowing for the resulting image to be further reduced as to the number of polygons used for representing the initial image.

From an algorithm perspective, the optimizing polygon reduction may typically be implemented as a feedback loop of at least two iterations. Thus, the inventive process may be illustrated by means of the below exemplifying pseudo-code:

RunReducerReduction( )

Do

MeasureViewDependentError( )

FeedbackViewDependentErrorIntoWeighting( )

RunReducerReduction( )

Until ReachedCutoff( )

As discussed above, the cutoff could be any or a combination of:

a certain number of iterations,

reached a certain number of triangles, and/or

a certain quality level is reached.

In summary, the present invention relates to a computer implemented method for optimizing polygon reduction of an initial three-dimensional graphics image, the method comprising performing a first polygon reduction process, resulting in a first three-dimensional graphics image being a polygon reduced representation of the initial three-dimensional graphics image, comparing the first three-dimensional graphics image with the initial three-dimensional graphics image, determining a visual error metric based on the result of the comparison between the first three-dimensional graphics image and the initial three-dimensional graphics image, and performing a second polygon reduction process, resulting in a second three-dimensional graphics image being a polygon reduced representation of the initial three-dimensional graphics object, if the visual error metric is outside of a predetermined error range.

By means of the invention, it is possible to automate the identification of visual error appearing when executing a polygon reduction process, thus resulting in the advantage of reducing cost by minimizing the amount of labor needed for achieving e.g. a visually appealing image.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium, specifically including a non-transitory computer-readable storage medium, which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art. Variations to the disclosed embodiments can be understood and effected by the skilled addressee in practicing the claimed invention, from a study of the drawings, the disclosure, and the appended claims. Furthermore, in the claims, the word “comprising” does not exclude other elements or steps, and the indefinite article “a” or “an” does not exclude a plurality.

1. A computer implemented method for optimizing polygon reduction of an initial three-dimensional graphics image, the method comprising:
performing a first polygon reduction process, resulting in a first three-dimensional graphics image being a polygon reduced representation of the initial three-dimensional graphics image;
comparing the first three-dimensional graphics image with the initial three-dimensional graphics image;
determining a visual error metric based on the result of the comparison between the first three-dimensional graphics image and the initial three-dimensional graphics image; and
performing a second polygon reduction process, resulting in a second three-dimensional graphics image being a polygon reduced representation of the initial three-dimensional graphics object, if the visual error metric is outside of a predetermined error range.

2. The method of claim 1, wherein the initial, the first and the second three-dimensional graphics image is a polygonal image comprising a plurality of polygons forming a 3-D computer graphics image.

3. The method of claim 1, wherein the second polygon reduction process introduces a lower level of polygon reduction as compared to the first polygon reduction process.

4. The method of claim 1, wherein the second polygon reduction process introduces a higher level of polygon reduction as compared to the first polygon reduction process.

5. The method of claim 3, wherein the second polygon reduction process is selected from one of a plurality of predetermined polygon reduction processes.

6. The method of claim 1, further comprising segmenting the three-dimensional graphics image into a plurality of portions, wherein the determination of the visual error metric is performed for each of the plurality of portions of the three-dimensional graphics image.

7. The method of claim 6, wherein the selection of polygon reduction processes for one of the portions of the initial three-dimensional graphics image is based on the visual error metric for that one portion.

8. The method of claim 1, further comprising providing the visual error metric to a user, and receiving a user adjusted visual error metric, wherein providing the visual error metric and receiving the user adjusted visual error metric are performed prior to performing the second polygon reduction process.

9. An image processing apparatus for optimizing polygon reductions of a three-dimensional graphics object, comprising:
means for performing a first polygon reduction process, resulting in a first three-dimensional graphics image being a polygon reduced representation of the initial three-dimensional graphics image;
means for comparing the first three-dimensional graphics image with the initial three-dimensional graphics image;
means for determining a visual error metric based on the result of the comparison between the first three-dimensional graphics image and the initial three-dimensional graphics image; and
means for performing a second polygon reduction process, resulting in a second three-dimensional graphics image being a polygon reduced representation of the initial three-dimensional graphics object, if the visual error metric is outside of a predetermined error range

10. The image processing apparatus of claim 9, wherein the initial, the first and the second three-dimensional graphics image is a polygonal image comprising a plurality of polygons forming a 3-D computer graphics image.

11. The image processing apparatus of claim 9, further comprising display means for displaying the at least one of the initial, the first or the second three-dimensional graphics image.

12. The image processing apparatus of claim 9, wherein the second polygon reduction process introduces a lower level of polygon reduction as compared to the first polygon reduction process.

13. The image processing apparatus of claim 9, wherein the second polygon reduction process introduces a higher level of polygon reduction as compared to the first polygon reduction process.

14. The image processing apparatus of claim 9, further comprising means for segmenting the initial three-dimensional graphics object into a plurality of portions, wherein the means for determination of the visual error metric is further configured for performing the determination for each of the plurality of portions of the initial three-dimensional graphics object.

15. The image processing apparatus of claim 14, wherein the selection of polygon reduction processes for one of the portions of the initial three-dimensional graphics object is based on the visual error metric for that one portion.

16. The image processing apparatus of claim 9, further comprising means for providing the visual error metric to a user, and means for receiving a user adjusted visual error metric, wherein the means for providing the visual error metric and means for receiving the user adjusted visual error metric are activated prior to performing the second polygon reduction process.

17. A non-transitory computer-readable storage medium storing a program which causes a computer to execute an image processing method of claim 1.

18. A computer program product comprising a non-transitory computer readable medium having stored thereon computer program means for controlling an image processing apparatus configured for optimizing polygon reductions of a three-dimensional graphics object, wherein the computer program product comprises:
code for performing a first polygon reduction process, resulting in a first three-dimensional graphics image being a polygon reduced representation of the initial three-dimensional graphics image;
code for comparing the first three-dimensional graphics image with the initial three-dimensional graphics image;
code for determining a visual error metric based on the result of the comparison between the first three-dimensional graphics image and the initial three-dimensional graphics image; and
code for performing a second polygon reduction process, resulting in a second three-dimensional graphics image being a polygon reduced representation of the initial three-dimensional graphics object, if the visual error metric is outside of a predetermined error range.

19. The computer program product of claim 16, further comprising code for displaying the at least one of the initial, the first or the second three-dimensional graphics image on a computer screen.

20. The method of claim 4, wherein the second polygon reduction process is selected from one of a plurality of predetermined polygon reduction processes.
